(19) United States
(12) Patent Application Publication
(10) Pub. No.: US 2023/0366249 A1
(43) Pub. Date: Nov. 16, 2023

(54) Hinge for Detachably and Pivotably Connecting a Leaf to a Base Part

(71) Applicant: DIRAK Dieter Ramsauer Konstruktionselemente GmbH, Ennepetal (DE)

(72) Inventors: Frank Nöthe, Witten (DE); Peter Hoschler, Velbert (DE)

(21) Appl. No.: 18/043,913

(22) PCT Filed: Jul. 27, 2021
(86) PCT No.: PCT/EP2021/070928

§ 371 Date: Mar. 3, 2023

(30) Foreign Application Priority Data
Sep. 7, 2020 (DE) 10 2020 123 253.5

(51) Int. Cl. E05D 7/10; E05D 3/02; E05D 5/06; E05B 65/00

(52) U.S. Cl. CPC E05D 7/1061; E05D 3/02; E05D 5/06; E05B 65/00; E05Y 2201/22; E05Y 2900/208

(57) ABSTRACT

Illustrated and described is a hinge for releasably and pivotably connecting a wing, in particular in the form of a door and/or a flap, to a base part, in particular in the form of a frame, including: a hinge pin extending along a pin axis, and at least one pin-receiving element, which has a pin receptacle for at least partially receiving the hinge pin, wherein the hinge pin is adjustable relative to the pin-receiving element, at least substantially perpendicularly to the pin axis, between a pivoting position in which it is at least partially received in the pin receptacle and a mounting position in which it is arranged outside of the pin receptacle, wherein the pin-receiving element and the hinge pin are pivotable relative to one another about the pin axis in the pivoting position, and wherein a securing element is provided which is adjustable between a securing position for securing the hinge pin with respect to an unintentional adjustment from the pivoting position into the mounting position at least substantially perpendicularly to the pin axis and a release position for releasing the adjustment, at least substantially perpendicularly to the pin axis, of the hinge pin from the pivoting position into the mounting position. Also illustrated and described is a system having such a hinge.

### CROSS-REFERENCE TO RELATED APPLICATIONS

This application is the United States national phase of International Application No. PCT/EP2021/070928 filed Jul. 27, 2021, and claims priority to German Patent Application No. 10 2020 123 253.5 filed Sep. 7, 2020, the disclosures of which are hereby incorporated by reference in their entireties.

### BACKGROUND OF THE INVENTION

### Field of the Invention

The invention relates to a hinge for detachably and pivotably connecting a leaf, in particular in the form of a door and/or a flap, to a base part, in particular in the form of a frame.

In addition, the invention relates to a system comprising a leaf, in particular in the form of a door and/or a flap, a base part, in particular in the form of a frame, and at least one hinge, wherein the leaf can be detachably and pivotably connected to the base part by means of the hinge and wherein the leaf can be pivoted relative to the base part in the state connected to the base part about a pin axis of the hinge between a closed position for closing an access and an open position for at least partially releasing the access.

### Description of Related Art

Hinges for detachably and pivotably connecting a leaf to a base part are known in different configurations and are used in different areas. The assembly of doors on corresponding frames represents a common area of application for hinges. For example, house doors and room doors are assembled on door frames provided for this purpose and furniture doors are assembled on frames formed by corresponding furniture frames by means of hinges. Hinges are also used for control cabinets, which are often designed as sheet metal cabinets, in order to assemble one or a plurality of control cabinet doors of the respective control cabinet on a frame of the control cabinet. Another common area of application of hinges is the assembly of flaps on associated base parts, often also designed as frames. Flaps are typically used to close and release access to a wide variety of containers.

Irrespective of the design of the leaf and the base part, the leaf is typically assembled on the base part by one or a plurality of so-called hinge connections being established between the leaf and the base part via one or a plurality of hinges. In this case, for each hinge connection, a pin element of the hinge, which has a hinge pin extending along a pin axis, is often firstly fastened to the leaf and a pin receiving element of the hinge, which has a pin receiver for at least partially receiving the hinge pin, is fastened to the base part or vice versa. The hinge pin fastened to the leaf or the base part is then pushed along the pin axis into the pin receiver fastened to the corresponding other component and thus the hinge connection is established. Hinges are also known which have two pin receiving elements each with a pin receiver and a hinge pin extending along a pin axis. In the case of such hinges, in order to establish a hinge connection, one of the pin receiving elements is typically fastened to the leaf and the base part in each case and then the pin receiving elements fastened to the leaf and the base part are brought into a defined position relative to one another such that the hinge pin can be pushed along the pin axis into the two pin receivers of the different pin receiving elements.

The leaf is disassembled from the base part accordingly by detaching the one or more hinge connections which exist between the leaf and the base part. Depending on the design of the hinge, this generally takes place by pulling the hinge pin of the pin element fastened to the leaf or the base part along the pin axis out of the pin receiver fastened to the corresponding other component or by pulling the hinge pin along the pin axis out of the two pin receivers of the pin receiving elements fastened to the leaf and the base part.

In practice, hinges must meet different, sometimes conflicting requirements. Hinges should thus enable quick and easy assembly of the leaf on the base part and disassembly of the leaf from the base part. At the same time, it must be ensured that a hinge connection between the leaf and the base part established by means of the hinge does not unintentionally detach when the leaf is pivoted with respect to the base part, even under high loads on the hinge. Last but not least, it should be possible to manufacture hinges simply and cost-effectively. The previously known hinges do not meet these requirements to a satisfactory extent.

### SUMMARY OF THE INVENTION

The object underlying the invention is therefore to design and further develop the hinge mentioned at the outset and described in more detail above as well as the system mentioned at the outset and described in more detail above in such manner that a hinge connection between a leaf and a base part can be easily and quickly established and detached at low production costs of the hinge and at the same time an accidental detachment of the hinge connection is prevented as far as possible.

This object is achieved by a hinge for detachably and pivotably connecting a leaf, in particular in the form of a door and/or a flap, to a base part, in particular in the form of a frame, comprising: a hinge pin extending along a pin axis, and at least one pin receiving element, which has a pin receiver for at least partially receiving the hinge pin, wherein the hinge pin can be adjusted relative to the pin receiving element at least substantially perpendicular to the pin axis between a pivot position at least partially received in the pin receiver and an assembled position arranged outside the pin receiver, wherein the pin receiving element and the hinge pin can be pivoted relative to one another about the pin axis in the pivot position, and wherein a securing element is provided, which can be adjusted between a securing position for securing the hinge pin against an unintentional adjustment from the pivot position to the assembled position at least substantially perpendicular to the pin axis and a release position for releasing the adjustment of the hinge pin at least substantially perpendicular to the pin axis from the pivot position to the assembled position.

The hinge according to the invention is therefore designed to detachably connect a leaf to a base part in such manner that the leaf can be pivoted with respect to the base part. In this case, the hinge has a hinge pin which extends along a pin axis. The pin axis can expediently be the longitudinal axis of the hinge pin. In addition to the hinge pin, the hinge has at least one pin receiving element with a pin receiver, which is designed in such manner that the hinge pin can be at least partially received therein. In this case, the pin receiver can be formed by the pin receiving element for the sake of simplicity. Irrespective of this, it may be advisable if the pin receiving element has at least one fastening means for fastening the pin receiving element to the leaf or the base part. This enables the hinge to be easily and securely fastened to the leaf or the base part. For the same reason, it may alternatively or additionally also be advisable if the hinge pin is part of a pin element which has at least one fastening means for fastening the pin element to the leaf or the base part. In this case, the at least one fastening means of the pin receiving element and/or the pin element can be designed simply and cost-effectively as a bore.

The hinge pin can be adjusted relative to the pin receiving element from a pivot position to an assembled position and back, namely in a direction which is arranged at least substantially perpendicular to the pin axis. In this case, the hinge pin is received in the pivot position at least partially in the pin receiver of the pin receiving element, namely such that the pin receiving element and the hinge pin can be pivoted relative to one another about the pin axis of the hinge pin. In the assembled position, on the other hand, the hinge pin is arranged outside the pin receiver. The hinge pin can therefore be easily inserted into the pin receiver by adjustment at least substantially perpendicular to the pin axis and removed from the pin receiver. This makes it easy to establish and detach a hinge connection. For this purpose, it may be particularly advantageous if the connection between the hinge pin and the pin receiving element is disengaged in the assembled position of the hinge pin. If the hinge pin is in the assembled position, the hinge pin and the pin receiving element can thus in particular be unconnected. Irrespective of this, it can further simplify the establishing and detaching of the hinge connection if the hinge pin can be displaced at least substantially perpendicular to the pin axis from the pivot position to the assembled position and back. In this case, the adjustment of the hinge pin between the pivot position and the assembled position can be carried out in a simple manner by displacement.

In order to secure the hinge pin in the pivot position received at least partially in the pin receiver and thus to ensure that the hinge connection does not unintentionally detach when the leaf is pivoted relative to the base part, the hinge lastly has a securing element. The securing element can be adjusted from a securing position to a release position and back. In this case, the securing position serves to secure the hinge pin against unintentional adjustment at least substantially perpendicular to the pin axis from the pivot position to the assembled position. The release position serves to release the adjustment of the hinge pin at least substantially perpendicular to the pin axis from the pivot position to the assembled position. With regard to the functioning of the hinge, it is expedient if, in the pivot position of the hinge pin and in the securing position of the securing element, the pin receiving element and the hinge pin are connected to one another in such manner that the pin receiving element and the hinge pin can be pivoted relative to one another about the pin axis.

According to one configuration of the hinge, it is provided that the securing element can be pivoted about a securing pivot axis from the securing position to the release position and back. This not only makes it possible to easily adjust the securing element between the securing position and the release position, but also lends itself with regard to a simple and compact design of the hinge. Against this background, it may also be advisable if the securing pivot axis is arranged at least substantially parallel to the pin axis of the hinge pin, namely in relation to the alignment of the hinge pin in the pivot position.

Irrespective of whether or not the adjustment of the securing element between the securing position and the release position can be carried out by pivoting, it may be advisable if the securing element is held on the pin receiving element so as to be adjustable between the securing position and the release position. This also has a positive effect on the easy handling of the securing element. In this case, particularly easy handling can be achieved if the securing element is held on the pin receiving element so as to be adjustable in a guided manner between the securing position and the release position. In this case, the securing element can in particular be held on the pin receiving element such that the securing element cannot be adjusted in any direction, but preferably only along a single adjustment path from the securing position to the release position and back.

According to a further configuration of the hinge, the securing element can be adjusted from the release position to the securing position by adjusting the hinge pin from the assembled position to the pivot position. Thus, adjusting the hinge pin from the assembled position to the pivot position can effect the adjustment of the securing element from the release position to the securing position. Thus, the hinge connection can be established particularly easily and quickly, since the securing element does not have to be adjusted separately from the release position to the securing position after the hinge pin has been inserted into the pin receiver. In addition, it can be ensured in this way that the securing element does not accidentally remain in the release position when the hinge connection is established, which would prevent the hinge from functioning reliably. It may also be advisable if the securing element can be adjusted in a positive-locking manner from the release position to the securing position by adjusting the hinge pin from the assembled position to the pivot position. Thus, when adjusting the hinge pin from the assembled position to the pivot position, the securing element can be adjusted from the release position to the securing position by physical contact with the hinge pin. This can have a positive effect on a simple and cost-effective configuration of the hinge.

Alternatively or additionally, it can be advantageous with regard to a simple and quick detachment of the hinge connection if the securing element can be adjusted from the securing position to the release position by adjusting the hinge pin from the pivot position to the assembled position. The adjustment of the securing element from the securing position to the release position can then be effected by adjusting the hinge pin from the pivot position to the assembled position. In particular, the securing element does not have to be adjusted separately from the securing position to the release position before removing the hinge pin from the pin receiver. With regard to a simple and cost-effective configuration of the hinge, it may also be advantageous if the securing element can be adjusted in a positive-locking manner from the securing position to the release position by adjusting the hinge pin from the pivot position to the assembled position. Thus, when adjusting the hinge pin from the pivot position to the assembled position, the securing element can be adjusted from the securing position to the release position by physical contact with the hinge pin.

A further configuration of the hinge envisages the pin receiver having an assembly opening for inserting the hinge pin into the pin receiver and removing the hinge pin from the pin receiver. Thus, the hinge pin can be easily adjusted through the assembly opening from the assembled position to the pivot position and back. Irrespective of this, the assembly opening can be at least partially closed by the securing element when the securing element is in the securing position. In this way, securing the hinge pin against adjustment from the pivot position to the assembled position can be realised in a constructively simple manner. In order to ensure that the securing element in the release position does not impede the adjustment of the hinge pin from the pivot position to the assembled position, it may also be advisable for the assembly opening to be at least substantially released by the securing element when the securing element is in the release position. Irrespective of this, for the sake of simplicity, the assembly opening can extend at least substantially parallel to the pin axis of the hinge pin, namely in relation to the alignment of the hinge pin in the pivot position.

According to a further configuration of the hinge, it is provided that the securing element can be adjusted from the release position in the direction of the securing position against a restoring force returning the securing element to the release position. This prevents the securing element from unintentionally moving from the release position to a position in which it impedes the adjustment of the hinge pin from the assembled position to the pivot position and thus the establishment of the hinge connection. At the same time, a user can easily adjust the securing element from the release position to the securing position. In this case, it is not absolutely necessary for the restoring force returning the securing element to the release position to act along the entire adjustment path of the securing element from the release position to the securing position. Rather, it may be sufficient for the aforementioned purpose if the restoring force returning the securing element to the release position acts from the release position only along a part of the adjustment path of the securing element from the release position to the securing position. Irrespective of this, the restoring force returning the securing element to the release position can be effected by a spring means for the sake of simplicity. The restoring force returning the securing element to the release position can then be the proportion of the spring force of the spring means which acts in the direction of the adjustment path of the securing element in the respective position of the securing element. Irrespective of how the restoring force returning the securing element to the release position is effected, the securing element can rest on the pin receiving element in the release position in the direction of the restoring force returning the securing element to the release position. If the securing element is in the release position, the securing element can therefore be pressed against the pin receiving element by the restoring force returning the securing element to the release position. In this way, the securing element can be held in a defined position in the release position in a constructively simple manner.

A further configuration of the hinge is characterised in that the securing element can be adjusted from the securing position in the direction of the release position against a restoring force returning the securing element to the securing position. In this way, it can be avoided that the securing element unintentionally moves from the securing position to a position in which it releases the adjustment of the hinge pin from the pivot position to the assembled position, which positively affects a reliable securing of the hinge pin in the pin receiver. At the same time, a user can easily adjust the securing element from the securing position to the release position, which positively affects a simple detachment of the hinge connection. Here too, it is not absolutely necessary for the restoring force returning the securing element to the securing position to act along the entire adjustment path of the securing element from the securing position to the release position. Rather, it may be sufficient for the aforementioned purpose if the restoring force returning the securing element to the securing position acts from the securing position only along a part of the adjustment path of the securing element from the securing position to the release position. Irrespective of this, the restoring force returning the securing element to the securing position can be effected by a spring means for the sake of simplicity. The restoring force returning the securing element to the securing position can then be the proportion of the spring force of the spring means which acts in the direction of the adjustment path of the securing element in the respective position of the securing element. Irrespective of how the restoring force returning the securing element to the securing position is effected, it may be advisable for the securing element to rest on the pin receiving element in the securing position in the direction of the restoring force returning the securing element to the securing position. If the securing element is in the securing position, the restoring force returning the securing element to the securing position thus preferably presses the securing element against the pin receiving element. In this way, the securing element can be held in a defined position in the securing position in a constructively simple manner.

The securing element can therefore be adjusted, on the one hand, against the restoring force returning the securing element to the release position from the release position in the direction of the securing position and, on the other hand, against the restoring force returning the securing element to the securing position from the securing position in the direction of the release position. In this way, an unintentional adjustment of the securing element both from the securing position and from the release position can be reliably avoided without significantly increasing the effort required to establish and detach the hinge connection. Then, for the sake of simplicity, the securing element can be adjusted adopting an intermediate position from the securing position to the release position and back, wherein the securing element can be adjusted from the release position to the intermediate position against the restoring force returning the securing element to the release position and from the securing position to the intermediate position against the restoring force returning the securing element to the securing position. Between the securing position and the intermediate position, the restoring force returning the securing element to the securing position can act on the securing element and between the intermediate position and the release position the restoring force returning the securing element to the release position can act on the securing element. Irrespective of this, it may be advantageous in terms of reliably securing the hinge pin in the pin receiver if the restoring force returning the securing element to the securing position is greater than the restoring force returning the securing element to the release position. In this case, in particular to adjust the securing element from the securing position to the release position, a greater force must be applied than to adjust the securing element from the release position to the securing position. With regard to a simple structural configuration of the hinge, however, it may alternatively also be advisable if the restoring force returning the securing element to the securing position and the restoring force returning the securing element to the release position are at least substantially the same.

If both the restoring force returning the securing element to the securing position and the restoring force returning the securing element to the release position are provided, the two restoring forces can be effected in a particularly space-saving manner by the same spring means. The spring means can then advantageously be provided such that the spring force of the spring means acts on the securing element either at least partially in the direction of the securing position or at least partially in the direction of the release position or perpendicular to these two directions as a function of the position of the securing element. In particular, the spring force of the spring means can act at least partially in the direction of the release position when the securing element is between the release position and the intermediate position and at least partially act in the direction of the securing position when the securing element is between the securing position and the intermediate position. In the intermediate position of the securing element, the spring force can then act preferably at least substantially perpendicular to the, in particular opposing, adjustment directions of the securing element. In this case, the spring means can also be designated as dead-centre spring. Alternatively, the restoring force returning the securing element to the securing position and the restoring force returning the securing element to the release position can also be provided by two different spring means. This can positively affect a simple and cost-effective design of the hinge. Then, depending on the position of the securing element, either the proportion of the spring force of the spring means acting in the direction of the release position to return the securing element to the release position can be greater than the proportion of the spring force of the spring means acting in the direction of the securing position to return the securing element to the securing position or vice versa or the corresponding proportions of the spring forces can cancel one another out.

Irrespective of whether the securing element can be adjusted against a restoring force from the release position in the direction of the securing position and/or from the securing position in the direction of the release position, according to a further configuration of the hinge, a locking element can be provided which can be adjusted between a locking position and an unlocking position. The adjustment of the securing element from the securing position to the release position can then be blocked in a positive-locking manner by the locking element when the locking element is in the locking position and can be released when the locking element is in the unlocking position. In this way, it can be particularly reliably avoided that the securing element unintentionally moves from the securing position to a position in which it releases the adjustment of the hinge pin from the pivot position to the assembled position. In this case, it can also be provided that the locking element engages in a positive-locking manner into a locking receptacle of the securing element in the locking position when the securing element is in the securing position. Thus, the positive blocking of the adjustment of the securing element from the securing position to the release position can be implemented in a constructively simple manner. In the unlocking position, the locking element can then be arranged expediently at least substantially outside the locking receptacle of the securing element when the securing element is in the securing position. This ensures that the locking element in the unlocking position does not impair the adjustment of the securing element from the securing position to the release position.

A further configuration of the hinge is characterised in that the locking element can be pivoted about a locking pivot axis from the locking position to the unlocking position and back. This can not only simplify the adjustment of the locking element between the locking position and the unlocking position, but can also be advantageous in terms of a simple and compact design of the hinge. A particularly simple and compact design can be achieved if the locking pivot axis is arranged at least substantially parallel or at least substantially perpendicular to the pin axis of the hinge pin in relation to its alignment in the pivot position.

Alternatively or additionally, it may also be advisable with regard to simple handling of the locking element if the locking element is held on the pin receiving element so as to be adjustable between the locking position and the unlocking position. In this case, the adjustment of the locking element between the locking position and the unlocking position can also be carried out particularly precisely if the locking element is held on the pin receiving element so as to be adjustable in a guided manner between the locking position and the unlocking position. This can further improve the handling of the locking element. In this case, the locking element is in particular held on the pin receiving element such that it cannot be adjusted in any direction, but preferably only along a single adjustment path from the locking position to the unlocking position and back.

According to a further configuration of the hinge, it is provided that the locking element can be adjusted automatically from the unlocking position to the locking position when the securing element is adjusted from the release position to the securing position. Thus, when adjusting the securing element from the release position to the securing position, the locking element can be automatically adjusted from the unlocking position to the locking position, in particular without the adjustment of the locking element from the unlocking position to the locking position having to be effected separately. In this way, not only is the establishing of the hinge connection simplified, but it can also be ensured that the locking element does not unintentionally remain in the unlocking position when establishing the hinge connection, which would lead to an inadequate securing of the hinge pin in the pin receiver.

Alternatively or additionally, it can also be provided that the adjustment of the locking element from the unlocking position to the locking position is blocked in a positive-locking manner by the securing element when the securing element is in the release position. In this way, it can be ensured in a constructively simple manner that the locking element remains in the unlocking position as long as the securing element is in the release position. This prevents the adjustment of the securing element from the release position to the securing position being impeded by the locking element. In order to simultaneously enable a problem-free adjustment of the locking element from the unlocking position to the locking position when the securing element is in the securing position, the adjustment of the locking element from the unlocking position to the locking position can be released by the securing element in the securing position.

A further configuration of the hinge provides that the locking element can be adjusted from the locking position in the direction of the unlocking position against a restoring force returning the locking element to the locking position. This prevents the locking element from unintentionally moving from the locking position to a position in which it releases the adjustment of the securing element from the securing position to the release position. This further increases safety against unintentional detachment of the hinge connection. The locking element can then preferably be adjusted from the locking position to the unlocking position against the restoring force returning the locking element to the locking position. In this case, in particular the restoring force returning the locking element to the locking position acts not only along a part of the adjustment path of the locking element from the locking position to the unlocking position, but at least substantially along the entire adjustment path. On the one hand, this has the advantage that the locking element does not unintentionally remain in the unlocking position. On the other hand, this can contribute to a simple implementation of an automatic adjustment of the locking element from the unlocking position to the locking position when adjusting the securing element from the release position to the securing position. Irrespective of this, the restoring force returning the locking element to the locking position can be effected by a spring means for the sake of simplicity.

If the locking element can be adjusted against the restoring force returning the locking element to the locking position from the locking position in the direction of the unlocking position, the locking element in the locking position can rest on the securing element in the securing position in the direction of the restoring force returning the locking element to the locking position. In this case, the restoring force returning the locking element to the locking position can press the locking element against the securing element when the locking element is in the locking position and the securing element is in the securing position. In this way, the locking element can be held in a defined position in the locking position in a constructively simple manner. Irrespective of this, if the locking element can be adjusted from the locking position to the unlocking position against the restoring force returning the locking element to the locking position, it can also be provided that the locking element in the unlocking position rests on the securing element in the release position in the direction of the restoring force returning the locking element to the locking position. In this case, the restoring force returning the locking element to the locking position can press the locking element against the securing element when the locking element is in the unlocking position and the securing element is in the release position. This can contribute to a constructively simple implementation of an automatic adjustment of the locking element from the unlocking position to the locking position when adjusting the securing element from the release position to the securing position.

According to a further configuration of the hinge, it is provided that the securing element can be adjusted from the release position to the securing position against a restoring force returning the securing element to the release position. In this case, in particular the restoring force returning the securing element to the release position acts along at least substantially the entire adjustment path of the securing element from the release position to the securing position. This can, in principle, be useful in order to simplify the adjustment of the securing element from the securing position to the release position and thus the detachment of the hinge connection. However, this is particularly useful if a locking element is provided such that at the same time it is prevented that the securing element unintentionally moves from the securing position to a position releasing the adjustment of the hinge pin from the pivot position to the assembled position by way of the restoring force returning the securing element to the release position. In this case, an unintentional adjustment of the securing element from the securing position can be avoided particularly easily and reliably if the securing element in the securing position rests on the locking element in the locking position in the direction of the restoring force returning the securing element to the release position. Alternatively or additionally, it can also be provided that the securing element in the release position rests on the locking element in the unlocking position in the direction of the restoring force returning the securing element to the release position. In this way, the securing element can be held in a defined position in the release position in a constructively simple manner. Irrespective of this, the restoring force returning the securing element to the release position can be effected simply and cost-effectively by a spring means.

According to a further configuration of the hinge, the locking element can be adjusted from the locking position to the release position and/or back without tools. The locking element can then in particular be adjusted manually from the locking position to the unlocking position and/or back. In this way, the establishing and/or detaching of the hinge connection can be further simplified and carried out in a shorter time. In this case, the adjustment of the locking element can be carried out particularly easily and quickly without tools if the locking element has at least one pressure surface in such manner that the locking element can be adjusted from the locking position to the unlocking position and/or back by applying a compressive force on the pressure surface at least substantially perpendicular to the pressure surface.

Irrespective of whether or not the locking element can be adjusted between the locking position and the unlocking position without tools, the locking element can have a shaped section. The shaped section can then be designed such that a correspondingly designed tool and/or correspondingly designed key are placed thereon and then the locking element can be adjusted from the locking position to the unlocking position and/or back by means of the tool and/or the key. This means that authorised persons, who are in possession of a corresponding tool and/or key, can adjust the locking element easily and without great effort. If, in addition, the adjustment of the locking element cannot be adjusted without a corresponding tool and/or corresponding key or can only be adjusted with considerable effort, this can also contribute to increased security against unauthorised adjustment of the locking element. Irrespective of this, the hinge can comprise a corresponding tool and/or a corresponding key for the sake of simplicity. In this case, in particular the tool and/or the key is part of the hinge.

Finally, a further configuration of the hinge is characterised in that the securing element has a pin receiver for at least partially receiving the hinge pin. In this case, the hinge pin can be received in the pivot position not only at least partially in the pin receiver of the pin receiving element, but also at least partially in the pin receiver of the securing element when the securing element is in the securing position. This can positively affect a defined and precise pivoting of the hinge pin and the pin receiving element relative to one another. Alternatively or additionally, it may also be advisable against the same background if the pin receiver of the pin receiving element and/or the pin receiver of the securing element has a cross-section which is at least in sections at least substantially arc-shaped. In this case, a cross-section of the pin receiving element and/or the securing element is in particular understood as a cross-section which is arranged perpendicular to the pin axis of the hinge pin, namely in relation to the alignment of the hinge pin in the pivot position. Alternatively or additionally, it can also contribute to a defined and precise pivoting of the hinge pin and the pin receiving element relative to one another if the hinge pin has a cross-section which is at least substantially circular. In this case, a cross-section of the hinge pin is understood in particular as a cross-section which is arranged perpendicular to the pin axis of the hinge pin.

The object described above is also achieved in a system as described herein in that the hinge is designed as described herein.

The system according to the invention comprises a leaf, a base part and at least one hinge of the type described above. In this case, the leaf can be detachably connected to the base part by means of the hinge in such manner that the leaf can be pivoted about the pin axis of the hinge pin from a closed position to an open position and back. The leaf can then in the closed position at least substantially close an access, which for the sake of simplicity can be at least partially delimited by the base part, and in the open position at least partially release the access. With such a system, the aforementioned advantages of the hinge are particularly effective. This applies all the more if the leaf is designed as a door and/or flap and/or if the base part is designed as a frame. For the same reason, it may alternatively or additionally be advisable if the leaf and the base part belong to a sheet metal cabinet. The base part can then be formed by a body of the sheet metal cabinet and the leaf can be formed at least substantially from sheet metal.

According to one configuration of the system, it is provided that the adjustment of the securing element from the securing position to the release position and/or the adjustment of the locking element from the locking position to the unlocking position is blocked in a positive-locking manner by the leaf when the leaf is in the closed position. This reliably prevents the hinge connection from detaching in the closed position of the leaf. In order to simultaneously enable problem-free detachment of the hinge connection in the open position of the leaf, the adjustment of the securing element from the securing position to the release position and/or the adjustment of the locking element from the locking position to the unlocking position can be released by the leaf when the leaf is in the open position.

If the hinge has a locking element with a shaped section for placing a tool and/or key, it can alternatively be provided that the leaf has an unlocking recess, which is arranged in the closed position of the leaf in the region of the shaped section of the locking element. The tool and/or the key can then be placed on the shaped section of the locking element through the unlocking recess of the leaf and the locking element can be adjusted by means of the tool and/or the key from the locking position to the unlocking position and/or back when the leaf is in the closed position. In this way, it can be ensured that authorised persons, who are in possession of a corresponding tool and/or key, can easily detach and/or establish the hinge connection even in the closed position of the leaf, but not or only with considerable effort by unauthorised persons.

### BRIEF DESCRIPTION OF THE DRAWINGS

The invention will be explained in more detail below on the basis of a drawing which simply represents preferred exemplary embodiments, in which is shown:

FIG. 1A-B: a first hinge according to the invention with a hinge pin in an assembled position and a pivot position in each case in a perspective view,

FIG. 2A-B: a first system according to the invention comprising the hinge from FIG. 1A-B with the hinge pin in the pivot position in a perspective view and a horizontal sectional view,

FIG. 3A-B: the system from FIG. 2A-B with the hinge pin in an assembled position in a perspective view and a horizontal sectional view,

FIG. 4A-B: a second hinge according to the invention with a hinge pin in an assembled position and a pivot position in each case in a perspective view,

FIG. 5A-B: a second system according to the invention comprising the hinge from FIG. 4A-B with the hinge pin in the pivot position in a perspective view and a horizontal sectional view,

FIG. 6A-B: the system from FIG. 5A-B with the hinge pin in an assembled position in a perspective view and a horizontal sectional view,

FIG. 7A-B: a third hinge according to the invention with a hinge pin in an assembled position and a pivot position in each case in a perspective view,

FIG. 8A-B: a third system according to the invention comprising the hinge from FIG. 7A-B with the hinge pin in the pivot position in a perspective view and a horizontal sectional view,

FIG. 9A-B: the system from FIG. 8A-B with the hinge pin in an assembled position in a perspective view and a horizontal sectional view.

### DESCRIPTION OF THE INVENTION

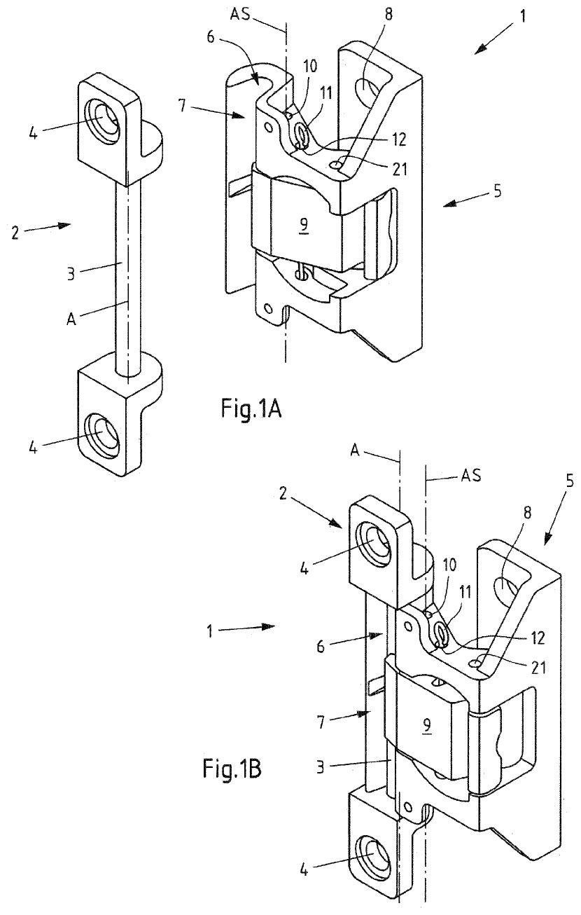

FIG. 1A-B show a hinge 1 in each case in a perspective view. The hinge 1 has a pin element 2 which comprises a, in this case, cylindrical hinge pin 3 extending along a pin axis A. At the opposing longitudinal ends of the hinge pin 3, the pin element 2 in each case has a fastening means in the form of a bore 4. By means of the bores 4, the pin element 2 can be fastened to a leaf, for example in the form of a door and/or a flap, or a base part, for example in the form of a frame, for example by screwing.

In addition to the pin element 2, the hinge 1 has a pin receiving element 5. The pin receiving element 5 has on its front side a pin receiver 6 with an assembly opening 7 through which the hinge pin 3 can be inserted into the pin receiver 6 and removed from the pin receiver 6. Like the pin element 2, the pin receiving element 5 has two fastening means on its rear side in the form of bores 8 by means of which the pin receiving element 5 can be fastened to a leaf or a base part.

A securing element 9 is held on the pin receiving element 5. In this case, the securing element 9 is held in the present case on a securing element axis 10 of the pin receiving element 5 extending at least substantially parallel to the pin receiver 6, which defines a securing pivot axis AS. Thus, the securing element 9 can be pivoted with respect to the pin receiving element 5 about the securing pivot axis AS in a guided manner. In addition, a spring means 11 in the form of a flexible wire is provided. The spring means 11 extends through two openings 12 of the pin receiving element 5 arranged on the opposing longitudinal sides of the securing element 9 and through an opening 13 of the securing element 9 not represented in FIG. 1A-B and arranged on the rear side of the securing element 9. In this case, the spring means 11 is bent over on the sides of the openings 12 of the pin receiving element 5 facing away from the securing element 9 and thus held in a simple manner on the pin receiving element 5.

The hinge pin 3 is represented in an assembled position and the securing element 9 is represented in a release position in FIG. 1A. In the assembled position, the hinge pin 3 is arranged outside the pin receiver 6 such that in the represented and in this respect preferred exemplary embodiment, the pin element 2 and the pin receiving element 5 are unconnected. In the release position, the securing element 9 substantially releases the assembly opening 7 of the pin receiver 6 such that the hinge pin 3 can be inserted into the pin receiver 6 to establish a hinge connection by displacement relative to the pin receiving element 5 at least substantially perpendicular to the pin axis A. Thus, the hinge pin 3 can be adjusted from the assembled position represented in FIG. 1A to a pivot position represented in FIG. 1B. The securing element 9 can be adjusted from the release position represented in FIG. 1A by pivoting relative to the pin receiving element 5 about the securing pivot axis AS into a securing position represented in FIG. 1B.

The hinge pin 3 is represented in the pivot position and the securing element 9 is represented in the securing position in FIG. 1B. In the pivot position, the hinge pin 3 is received in the pin receiver 6 of the pin receiving element 5 such that the pin element 2, and together with this, the hinge pin 3 can be pivoted relative to the pin receiving element 5 about the pin axis A. In this case, the securing element 9, adopting the securing position, partially closes the assembly opening 7 of the pin receiver 6 such that the hinge pin 3 is secured from an unintentional adjustment at least substantially perpendicular to the pin axis A out of the pin receiver 6. To detach the hinge connection, the securing element 9 can be adjusted from the securing position represented in FIG. 1B by pivoting about the securing pivot axis AS into the release position represented in FIG. 1A and the hinge pin 3 from the pivot position represented in FIG. 1B by displacement at least substantially perpendicular to the pin axis A into an assembled position, for example, the assembled position represented in FIG. 1A.

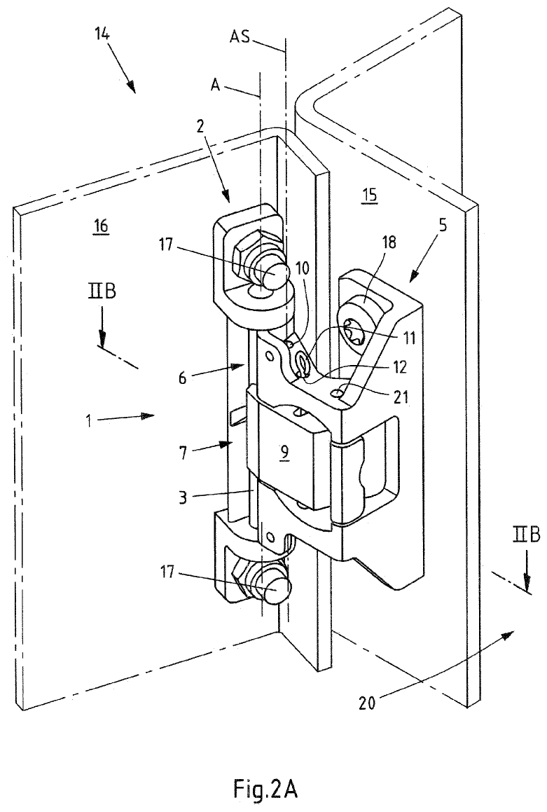

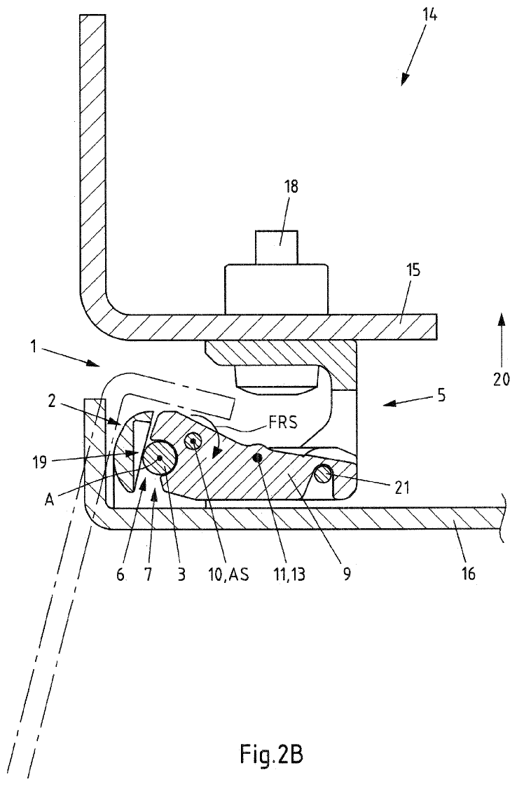

FIG. 2A-B show a system 14 with a base part 15 in the form of a frame, a leaf 16 in the form of a door and the hinge 1 in a perspective view and a horizontal sectional view along the section plane IIB-IIB represented in FIG. 2A. In this case, the base part 15 and the leaf 16 are only represented in sections. In the represented and in this respect preferred exemplary embodiment, the pin element 2 of the hinge 1 is fastened to the leaf 16 via its bores 4 by means of two screws 17 and the pin receiving element 5 of the hinge 1 is fastened to the base part 15 via its bores 8 by means of two screws 18. Alternatively, the pin element 2 could also be fastened to the base part 15 and the pin receiving element 5 to the leaf 16.

In the represented and in this respect preferred hinge 1, in addition to the pin receiving element 5, the securing element 9 also has a pin receiver 19 for partially receiving the hinge pin 3. In this case, the pin receiver 19 of the securing element 9 extends at least substantially parallel to the pin receiver 6 of the pin receiving element 5. The pin receiver 19 of the securing element 9 has a circular arc-shaped cross-section perpendicular to its longitudinal extension.

The hinge pin 3 is represented in the pivot position and the securing element 9 in the securing position in FIG. 2A-B. In this case, the hinge pin 3 is received in the pin receiver 6 of the pin receiving element 5 and partially in the pin receiver 19 of the securing element 9 such that the leaf 16 fastened to the pin element 2 can be pivoted about the pin axis A with respect to the base part 15 fastened to the pin receiving element 5. Thus, the leaf 16 can be pivoted with respect to the base part 15 between an open position represented in FIG. 2A and represented dashed in FIG. 2B and a closed position represented in FIG. 2B. In this case, the leaf 16 in the closed position closes an access 20, which is delimited laterally by the base part 15. In the open position, the leaf 16 releases the access 20.

In the securing position, a restoring force FRS returning the securing element 9 to the securing position acts on the securing element 9. The restoring force FRS returning the securing element 9 to the securing position presses the securing element 9 against a stop 21 of the pin receiving element 5, which is designed in the present case as a cylindrical axis extending parallel to the securing pivot axis AS. In this way, it is prevented that the securing element 9 is unintentionally pivoted out of the securing position and reaches a position in which it releases the assembly opening 7 of the pin receiver 6 such that the hinge pin 3 can come out of the pin receiver 6. The restoring force FRS is effected by the spring means 11 and is selected such that engagement and disengagement can take place without tools and without pressing any buttons.

If the leaf 16 is in the closed position, for example, the hinge connection can be detached. To this end, the hinge pin 3, together with the leaf 16 fastened thereto, can be displaced with respect to the pin receiving element 5 and the base part 15 fastened thereto, at least substantially perpendicular to the pin axis A from the pivot position represented in FIG. 2a-B to an assembled position in which the hinge pin 3 is arranged outside the pin receiver 6. In this case, the securing element 9 is pivoted by the contact with the hinge pin 3 against the restoring force FRS returning the securing element 9 to the securing position from the securing position represented in FIG. 2A-B and then pivoted to the release position in which the securing element 9 substantially releases the assembly opening 7 of the pin receiver 6.

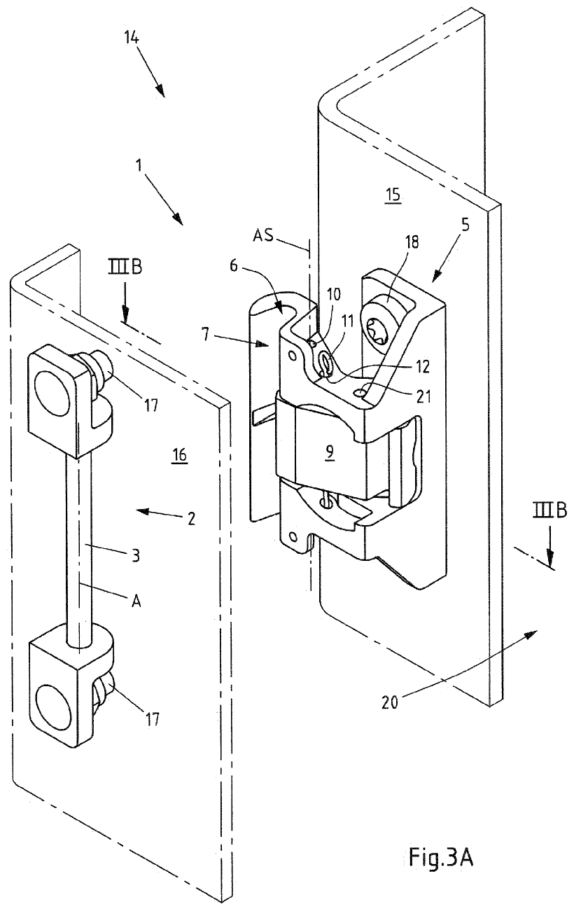

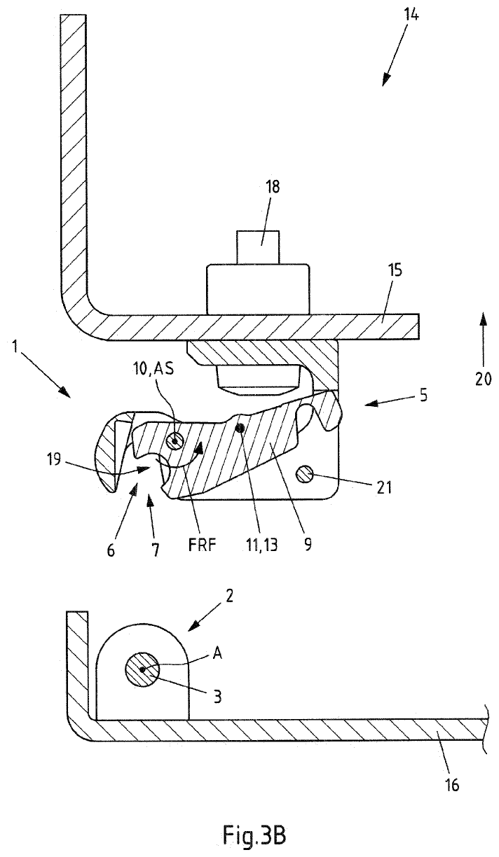

FIG. 3A-B show the system 14 in a perspective view and a horizontal sectional view along the section plane IIIB-IIIB represented FIG. 3A. In this case, the hinge pin 3 is represented in an assembled position and the securing element 9 is represented in the release position. In the assembled position, the hinge pin 3 is arranged outside the pin receiver 6 of the pin receiving element 5 and the pin receiver 19 of the securing element 9 such that the hinge connection between the base part 15 and the leaf 16 is separated.

In the release position, the securing element 9 substantially releases the assembly opening 7 of the pin receiver 6 such that the hinge pin 3 can be inserted into the pin receiver. In this case, a restoring force FRF returning the securing element 9 to the release position acts on the securing element 9, which presses the securing element 9 against the pin receiving element 5. In this way, it is prevented that the securing element 9 is unintentionally pivoted out of the release position and reaches a position in which it closes the assembly opening 7 of the pin receiver 6 so far that the insertion of the hinge pin 3 into the pin receiver 6 is impeded by the securing element 9. The restoring force FRF is also effected by the spring means 11.

In order to establish the hinge connection, the hinge pin 3, together with the leaf 16 fastened thereto, can be adjusted by displacement with respect to the pin receiving element 5 at least substantially perpendicular to the pin axis A from the assembled position represented in FIG. 3A-B to the pivot position represented in FIG. 2A-B. In this case, the securing element 9 is pivoted by the contact with the hinge pin 3 against the restoring force FRF returning the securing element 9 to the release position from the release position represented in FIG. 3A-B and then pivoted in the direction of the restoring force FRS returning the securing element 9 to the securing position to the securing position represented in FIG. 2A-B.

Pivoting the securing element 9 from the release position represented in FIG. 3A-B to the securing position represented in FIG. 2A-B and back is thus carried out via an intermediate position, wherein between the release position and the intermediate position, the restoring force FRF returning the securing element 9 to the release position acts on the securing element 9 and between the securing position and the intermediate position, the restoring force FRS returning the securing element 9 to the securing position. In the intermediate position, the securing element 9 is in an unstable equilibrium in which neither a force in the direction of the securing position nor a force in the direction of the release position acts on the securing element 9. This is achieved by the spring means 11 being untensioned in the intermediate position and only generating a restoring force FRF, FRS in one or the other direction when the hinge pin 3 engages or disengages.

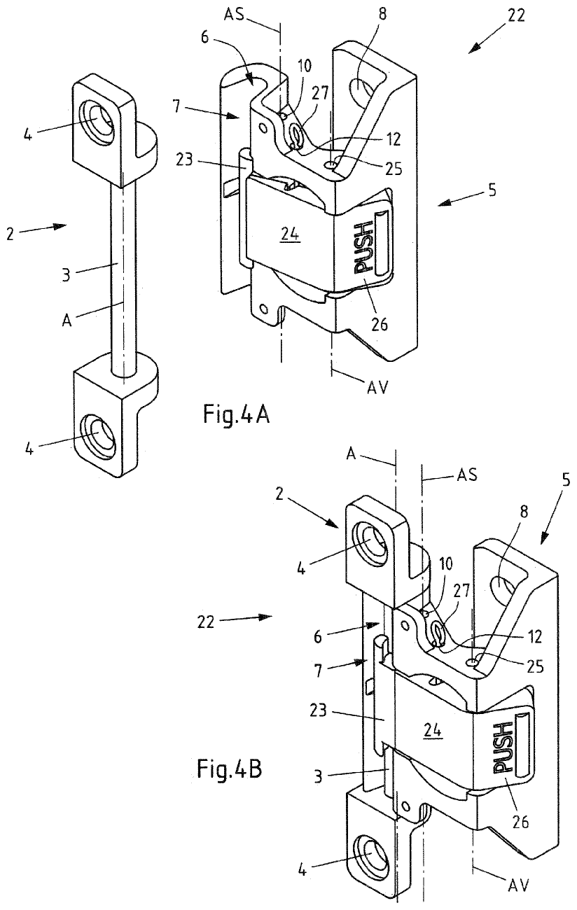

FIG. 4A-B show an alternative hinge 22 in each case in a perspective view, which is designed similarly to the hinge described above. For this reason, the same components also have the same reference numerals. However, there is a significant difference in terms of the mechanism for securing the hinge pin 3 in the pin receiver 6. Thus, in addition to a securing element 23, which is also held on the securing element axis 10 of the pin receiving element 5 so as to be pivotable about the securing pivot axis AS in the represented and in this respect preferred hinge 22, a locking element 24 is provided. The locking element 24 is held on a locking element axis 25 of the pin receiving element 5, which defines a locking pivot axis AV extending at least substantially parallel to the pin receiver 6. Thus, the locking element 24 can be pivoted about the locking pivot axis AV in a guided manner with respect to the pin receiving element 5. In this case, the locking element 24 has a pressure surface 26 for actuating the locking element 24. The pressure surface 26 is designed such that the locking element 24 can be pivoted about the locking pivot axis AV by applying a compressive force on the pressure surface 26 at least substantially perpendicular to the pressure surface 26.

Furthermore, a spring means 27 in the form of a flexible wire is provided. The spring means 27 extends through the two openings 12 of the pin receiving element 5, which are arranged on the opposing longitudinal sides of the locking element 24 in the represented and in this respect preferred exemplary embodiment. In addition, the spring means 27 extends through an opening 28 of the locking element 24 not represented in FIG. 4A-B and arranged on the rear side of the locking element 24. In this case, the spring means 27 is bent over in the present case on the sides of the openings 12 of the pin receiving element 5 facing away from the locking element 24 and thus held on the pin receiving element 5.

In FIG. 4A, the hinge pin 3 is represented in an assembled position, the securing element 23 in a release position and the locking element 24 in an unlocking position. In order to establish a hinge connection, the hinge pin 3 can be displaced from the assembled position represented in FIG. 4A at least substantially perpendicular to the pin axis A to the pivot position represented in FIG. 4B and the securing element 23 can be pivoted from the release position represented in FIG. 4A about the securing pivot axis AS to a securing position represented in FIG. 4B. The locking element 24 can then be adjusted from the unlocking position represented in FIG. 4A by pivoting about the locking pivot axis AV to a locking position represented in FIG. 4B.

In FIG. 4B, the hinge pin 3 is represented in the pivot position, the securing element 23 in the securing position and the locking element 24 in the locking position. In the locking position, the locking element 24 blocks the pivoting of the securing element 23 from the securing position to the release position in a positive-locking manner. In this way, it can be particularly reliably avoided that the securing element 23 unintentionally reaches a position in which it releases the assembly opening 7 of the pin receiver 6 such that the hinge pin 3 can come out of the pin receiver 6.

In order to detach a hinge connection established by means of the hinge 22, the locking element 24 can be pivoted from the locking position represented in FIG. 4B about the locking pivot axis AV to the unlocking position represented in FIG. 4A by applying a compressive force on the pressure surface 26. The securing element 23 can then be pivoted about the securing pivot axis AS from the securing position represented in FIG. 4B to the release position represented in FIG. 4A and the hinge pin 3 can be displaced at least substantially perpendicular to the pin axis A from the pivot position represented in FIG. 4B to an assembled position, for example, the assembled position represented in FIG. 4A.

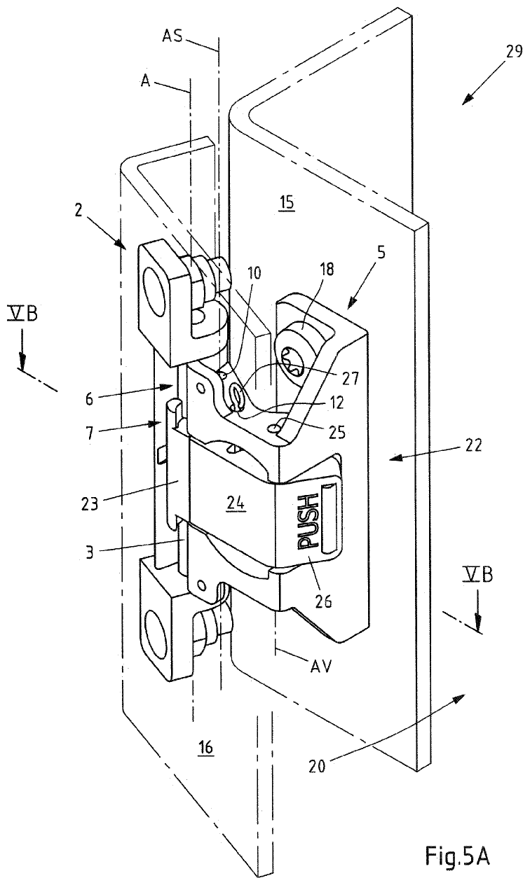

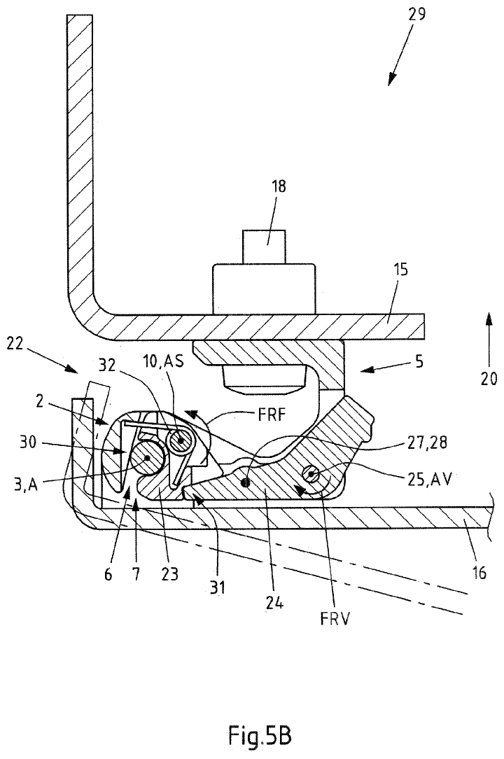

FIG. 5A-B show an alternative system 29 comprising the hinge 22 in a perspective view and a horizontal sectional view along the section plane VB-VB represented in FIG. 5A. Since the represented system 29 is designed similarly to the system described above, the same components also have the same reference numerals. Like the securing element of the previously described hinge, the securing element 23 of the represented and in this respect preferred hinge 22 also has a pin receiver 30. In this case, the pin receiver 30 of the securing element 23 extends parallel to the pin receiver 6 of the pin receiving element 5 and the pin receiver 30 of the securing element 23 has a circular arc-shaped cross-section perpendicular to its longitudinal extension.

In FIG. 5A-B, the hinge pin 3 is represented in the pivot position, the securing element 23 in the securing position and the locking element 24 in the locking position. The locking element 24 engages in a positive-locking manner into a locking receptacle 31 of the securing element 23 and thus blocks the pivoting of the securing element 23 about the securing pivot axis AS from the securing position to the release position in a positive-locking manner. In this case, the pretensioned spring means 27 extending through the opening 28 of the locking element 24 and the openings 12 of the pin receiving element 5 effects a restoring force FRV returning the locking element 24 to the locking position, which presses the locking element 24 against the securing element 23. Thus, the locking element 24 rests on the securing element 23 in the direction of the restoring force FRV returning the locking element 24 to the locking position.

In the depicted and in this respect preferred hinge 22, the securing element 23 is also spring-loaded, namely by a pretensioned spring means 32, which is designed in the present case as an elbow spring. In this case, the elbow spring is held on the securing element axis 10 of the pin receiving element 5, wherein the one leg of the elbow spring is supported on the pin receiving element 5 and the other leg of the elbow spring is supported on the securing element 23. In this way, the spring means 32 effects a restoring force FRF returning the securing element 23 to the release position such that the securing element 23 rests on the locking element 24 in the direction of this restoring force FRF.

In FIG. 5B, the leaf 16 is represented in the closed position. In the closed position, the leaf 16 blocks the pivoting of the locking element 24 about the locking pivot axis AV from the represented locking position to the unlocking position in a positive-locking manner. To detach the hinge connection, the leaf 16 can be adjusted from the closed position about the pin axis A to an open position represented in FIG. 5A and represented dashed in FIG. 5B, in which the leaf 16 partially releases the access 20. In this open position, the leaf 16 is arranged such that the locking element 24 can be pivoted from the locking position represented in FIG. 5A-B to the unlocking position against the restoring force FRV of the spring means 27 returning the locking element 24 to the locking position. The hinge pin 3, together with the leaf 16, can then be displaced from the pivot position represented in FIG. 5A and represented dashed in FIG. 5B perpendicular to the pin axis A to an assembled position in which the hinge pin 3 is arranged outside the pin receiver 6. In this case, the securing element 23 is pivoted from the securing position represented in FIG. 5A-B about the securing pivot axis AS to the release position.

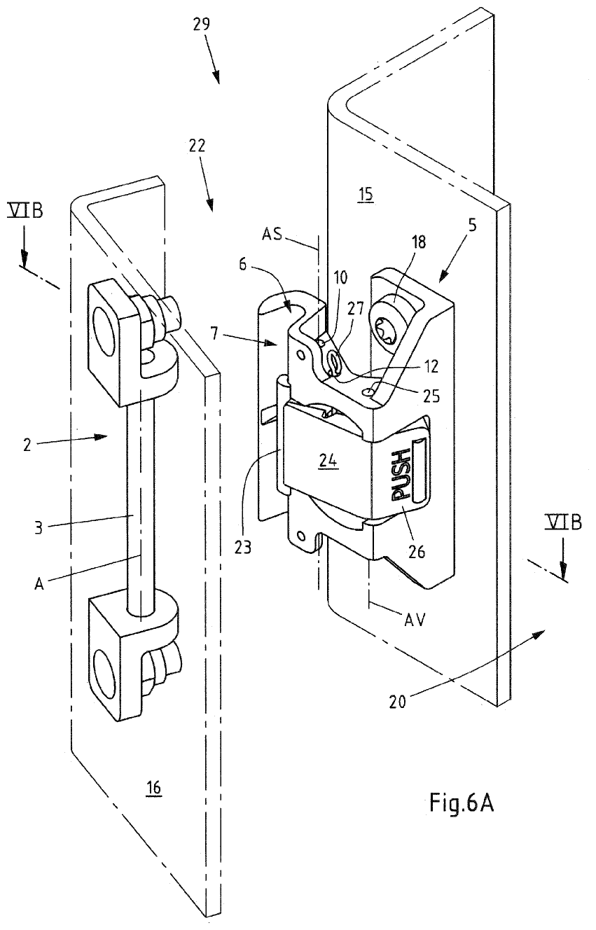

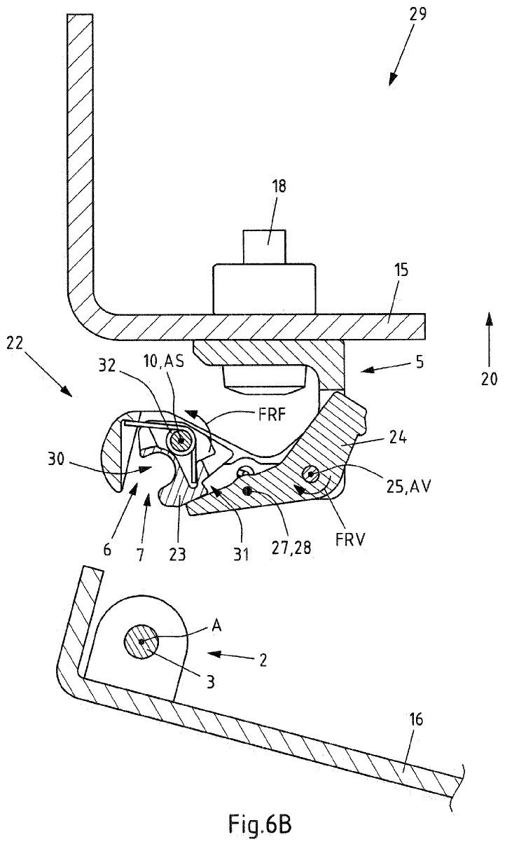

FIG. 6A-B show the system 29 in a perspective view and a horizontal sectional view along the section plane VIB-VIB represented in FIG. 6A, wherein the hinge pin 3 is represented in an assembled position, the securing element 23 in the release position and the locking element 24 in the unlocking position. The locking element 24 is arranged outside the locking receptacle 31. In this case, the locking element 24 is pressed against the securing element 23 by the restoring force FRV returning the locking element 24 to the locking position, which is effected by the wire-shaped spring means 27. Thus, the locking element 24 rests on the securing element 23 in the direction of the restoring force FRV returning the locking element 24 to the locking position. In addition, the securing element 23 is pressed against the locking element 24 by the restoring force FRF returning the securing element 23 to the release position, which is effected in the present case by the spring means 32 designed as an elbow spring, such that the securing element 23 rests on the locking element 24 in the direction of the restoring force FRF returning the securing element 23 to the release position.

In order to establish the hinge connection, the hinge pin 3, together with the leaf 16, can be displaced at least substantially perpendicular to the pin axis A from the assembled position represented in FIG. 6A-B to the pivot position represented in FIG. 5A-B. In this case, the securing element 23 is pivoted by the contact with the hinge pin 3 against the restoring force FRF returning the securing element 23 to the release position, which is effected by the spring means 32 designed as an elbow spring, from the release position represented in FIG. 6A-B to the securing position represented in FIG. 5A-B. The locking element 24 is then automatically pivoted by the restoring force FRV returning the locking element 24 to the locking position, which is effected by the wire-shaped spring means 27, from the unlocking position represented in FIG. 6A-B about the locking pivot axis AV to the locking position represented in FIG. 5A-B.

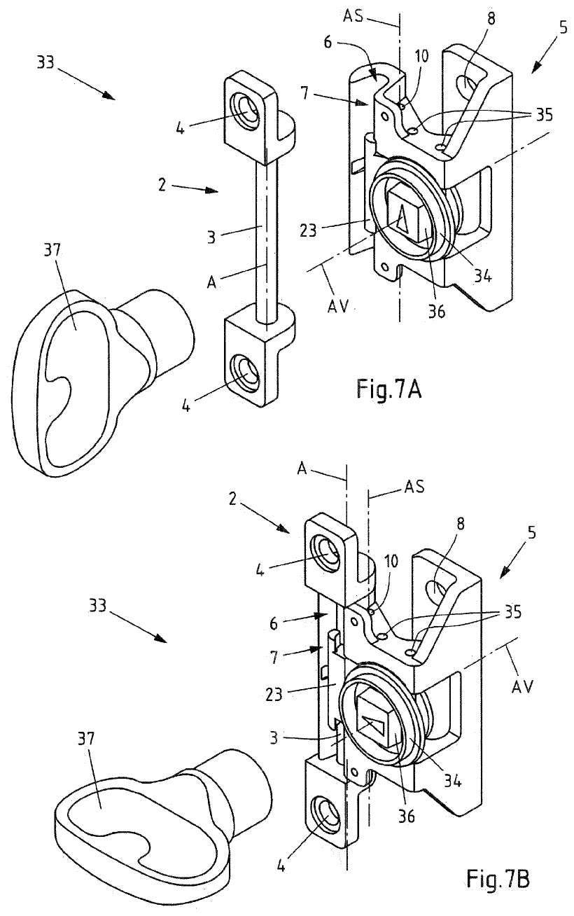

FIG. 7A-B show a further hinge 33 in each case in a perspective view which is similar to the hinge described above. For this reason, the same components also have the same reference numerals. A significant difference, however, is the design of the mechanism for locking the securing element 23 in the securing position. As with the previously described hinge, a locking element 34 is also held on the pin receiving element 5 in the represented and in this respect preferred hinge 33. In this case, however, the locking element 34 is held on two locking element axes 35 of the pin receiving element 5 extending at least substantially parallel to the pin receiver 6 such that the locking element 34 can be pivoted about a locking pivot axis AV, which is arranged at least substantially perpendicular to the pin axis A of the hinge pin 3 in relation to the alignment in the pivot position. The locking element axes 35 can, for example, be formed from a spring wire. As an alternative to retaining the locking element 34 by the two locking element axes 35, the locking element 34 could also be held by means of a special contour of the corresponding/adjoining components, wherein fixed stops can also be provided (e.g. +−90° from the closed position).

The locking element 34 has a shaped section 36, which is designed in the present case as a square. A correspondingly designed tool 37 can be placed on the shaped section 36, which is designed in the present case as a square spanner. The locking element 34 can then be pivoted about the locking pivot axis AV in a simple manner by means of the tool 37. In the represented and in this respect preferred exemplary embodiment, the shaped section 36 has a marking in the form of an arrow, which indicates the respective position in which the locking element 34 is located.

In FIG. 7A, the hinge pin 3 is represented in an assembled position, the securing element 23 in the release position and the locking element 34 in an unlocking position. In the release position, the securing element 23 releases the assembly opening 7 of the pin receiver 6 so far that the hinge pin 3 can be displaced at least substantially perpendicular to the pin axis A from the assembled position represented in FIG. 7A to the pivot position represented in FIG. 7B. As a result, the securing element 23 is pivoted from the release position represented in FIG. 7A about the securing pivot axis AS to the securing position represented in FIG. 7B. The locking element 34 can then be adjusted, for example, by means of the tool 37 from the unlocking position represented in FIG. 7A by pivoting about the locking pivot axis AV to a locking position represented in FIG. 7B.

In FIG. 7B, the hinge pin 3 is represented in the pivot position, the securing element 23 in the securing position and the locking element 34 in the locking position. In the locking position, the locking element 34 blocks the pivoting of the securing element 23 from the securing position to the release position in a positive-locking manner. In order to detach a hinge connection established by means of the hinge 33, the locking element 34 can be pivoted about the locking pivot axis AV, for example, by means of the tool 37 from the locking position represented in FIG. 7B to the unlocking position represented in FIG. 7A. The hinge pin 3 can then be moved at least substantially perpendicular to the pin axis A from the pivot position represented in FIG. 7B to an assembled position, for example, the assembled position represented in FIG. 7A. In this case, the securing element 23 is pivoted about the securing pivot axis AS from the securing position represented in FIG. 7B to the release position represented in FIG. 7A.

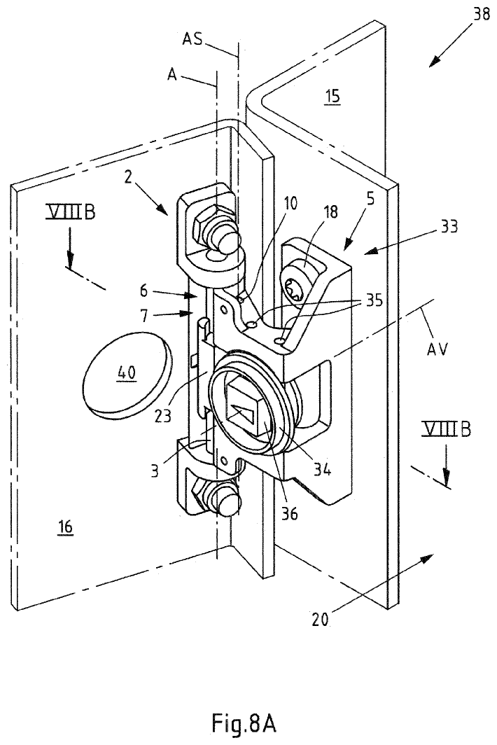

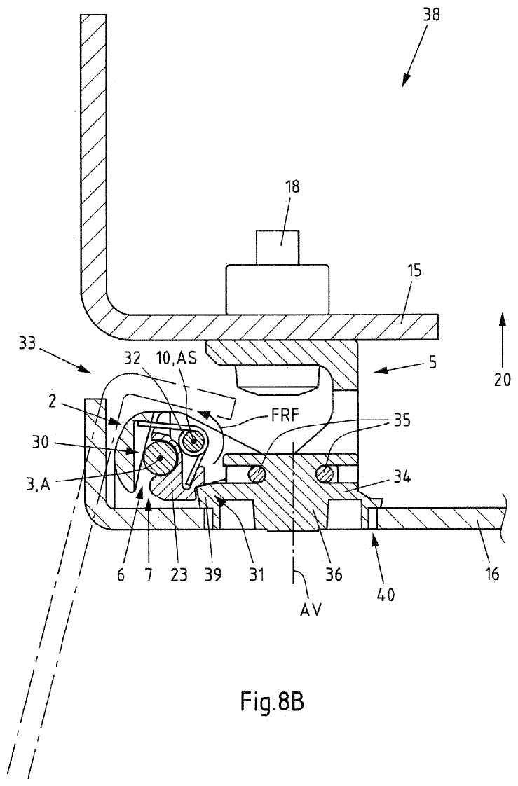

FIG. 8A-B show a further system 38 comprising the hinge 33 in a perspective view and a horizontal sectional view along the section plane VIIIB-VIIIB represented in FIG. 8A. Since the represented system 38 is designed similarly to the system described above, the same components also have the same reference numerals. In FIG. 8A-B, the hinge pin 3 is represented in the pivot position, the securing element 23 in the securing position and the locking element 34 in the locking position. In the locking position of the locking element 34, a lug 39 of the locking element 34 engages in the locking receptacle 31 of the securing element 23, whereby the pivoting of the securing element 23 about the securing pivot axis AS from the securing position to the release position is blocked in a positive-locking manner. In this case, the securing element 23 is pressed against the locking element 34 by the restoring force FRF returning the securing element 23 to the release position, which is effected by the spring means 32 designed as an elbow spring, such that the securing element 23 rests on the locking element 34 in the direction of the restoring force FRF returning the securing element 23 to the release position.

In the represented and in this respect preferred exemplary embodiment, the leaf 16 has an unlocking recess 40 designed in the present case in a circular shape. The tool 37 of the hinge 33 can be placed on the shaped section 36 of the locking element 34 through the unlocking recess 40 in the closed position of the leaf 16 represented in FIG. 8B, in which the leaf 16 closes the access 20. Thus, the locking element 34 can be pivoted about the locking pivot axis AV between the locking position and the unlocking position by means of the tool 37 in the closed position of the leaf 16.

To detach the hinge connection between the base part 15 and the leaf 16, the locking element 34 can, for example, in the closed position of the leaf 16 by means of the tool 37, be pivoted from the locking position represented in FIG. 8A-B about the locking pivot axis AV to the unlocking position. In this case, the lug 39 of the locking element 34 is pivoted out of the locking receptacle 31 of the securing element 23 such that the locking element 34 releases the pivoting of the securing element 23 about the securing pivot axis AS from the securing position to the release position. The hinge pin 3, together with the leaf 16, can then be displaced from the pivot position represented in FIG. 8A-B at least substantially perpendicular to the pin axis A to an assembled position in which the hinge pin 3 is arranged outside the pin receiver 6. In this case, the securing element 23 is pivoted from the securing position represented in FIG. 8A-B about the securing pivot axis AS to the release position at least substantially releasing the assembly opening 7 of the pin receiver 6.

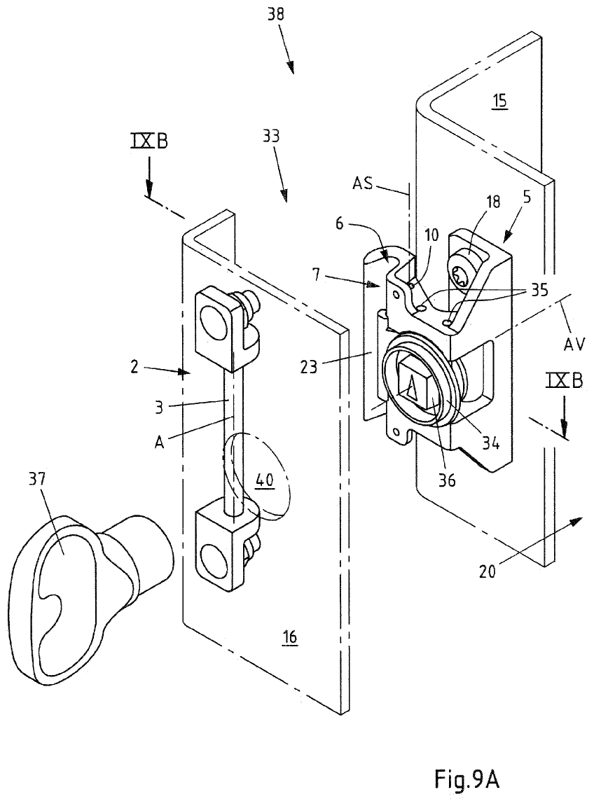

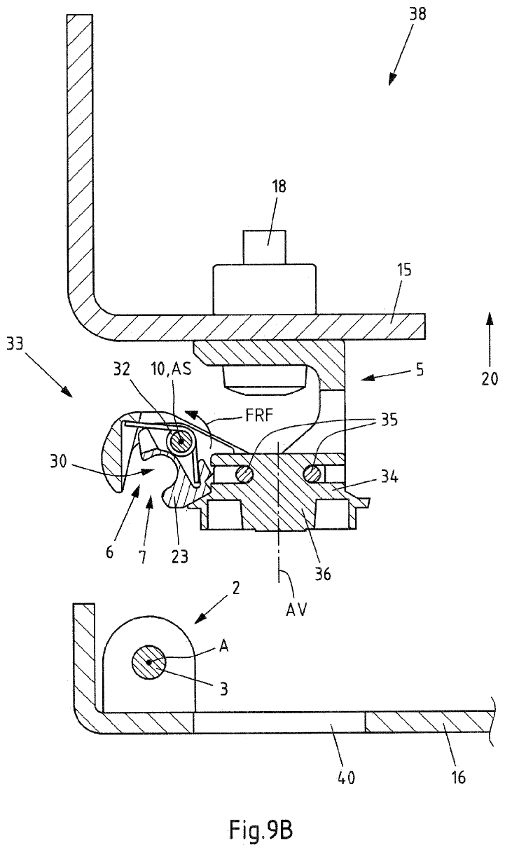

FIG. 9A-B show the system 38 in a perspective view and a horizontal sectional view along the section plane IXB-IXB represented in FIG. 9A, wherein the hinge pin 3 is represented in an assembled position, the securing element 23 in the release position and the locking element 34 in the unlocking position. In the release position, the securing element 23 is pressed against the locking element 34 by the restoring force FRF returning the securing element 23 to the release position, which is effected by the spring means 32 designed as an elbow spring. Thus, the securing element 23 rests on the locking element 34 in the direction of the restoring force FRF returning the securing element 23 to the release position.

In order to establish the hinge connection between the base part 15 and the leaf 16, the hinge pin 3, together with the leaf 16, can be displaced at least substantially perpendicular to the pin axis A from the assembled position represented in FIG. 9A-B to the pivot position represented in FIG. 8A-B. In this case, the securing element 23 is pivoted by the contact with the hinge pin 3 against the restoring force FRF returning the securing element 23 to the release position about the securing pivot axis AS from the release position represented in FIG. 9A-B to the securing position represented in FIG. 8A-B. Subsequently, for example, in the closed position of the leaf 16 by means of the tool 37, the locking element 34 can be pivoted about the locking pivot axis AV from the unlocking position represented in FIG. 9A-B to the locking position represented in FIG. 8A-B.

The two locking element axes 35 can, unlike as represented in FIG. 7A to FIG. 9B, also be extended so that their ends protrude upwards and/or downwards out of the pin receiving element 5. In addition, it can be provided that the ends are connected to one another above and/or below the pin receiving element 5, whereby a torsion-proof design results (U-shape or O-shape). Preferably, the ends are also inclined in the direction of the locking pivot axis AV in the direction of the leaf 16, i.e. “outwards”. As a result, the leaf 16, in its closed position, hits the inclined ends of the locking element axes 35 and elastically deforms them (the pretension path can, for example, be 2 mm to 3 mm). In this way, the locking element axes 35 act as a spring and generate a pretension with respect to the leaf 16 (e.g. a door leaf), which leads to the leaf 16 automatically springing open a little bit after unlocking, whereby it can be gripped more easily by hand and opened further. This is a particular advantage for completely enclosed doors.

### LIST OF REFERENCE NUMERALS

1: Hinge
2: Pin element
3: Hinge pin
4: Bore of the pin element
5: Pin receiving element
6: Pin receiver of the pin receiving element
7: Assembly opening
8: Bore of the pin receiving element
9: Securing element
10: Securing element axis
11: Spring means
12: Opening of the pin receiving element
13: Opening of the securing element
14: System
15: Base part
16: Leaf
17,18: Screw
19: Pin receiver of the securing element
20: Access
21: Stop
22: Hinge
23: Securing element
24: Locking element
25: Locking element axis
26: Pressure surface
27: Spring means
28: Opening of the locking element
29: System
30: Pin receiver of the securing element
31: Locking receptacle
32: Spring means
33: Hinge
34: Locking element
35: Locking element axis
36: Shaped section
37: Tool
38: System
39: Lug
40: Unlocking recess
A: Pin axis
AS: Securing pivot axis
AV: Locking pivot axis
FRF: restoring force returning the securing element to the release position
FRS: restoring force returning the securing element to the securing position
FRV: restoring force returning the locking element to the locking position

1. A hinge for detachably and pivotably connecting a leaf, in particular in the form of a door and/or a flap, to a base part, in particular in the form of a frame, comprising:
a hinge pin extending along a pin axis (A), and
at least one pin receiving element, which has a pin receiver for at least partially receiving the hinge pin,
wherein the hinge pin can be adjusted relative to the pin receiving element at least substantially perpendicular to the pin axis (A) between a pivot position received at least partially in the pin receiver and an assembled position arranged outside the pin receiver,
wherein the pin receiving element and the hinge pin can be pivoted relative to one another about the pin axis (A) in the pivot position, and
wherein a securing element is provided which can be adjusted between a securing position for securing the hinge pin with respect to an unintentional adjustment from the pivot position to the assembled position at least substantially perpendicular to the pin axis (A) and a release position for releasing the adjustment of the hinge pin at least substantially perpendicular to the pin axis (A) from the pivot position to the assembled position,
wherein the securing element can be moved from the release position into the securing position, in particular positively, by adjusting the hinge pin from the assembly position into the pivot position, and/or
the securing element can be adjusted from the securing position into the release position by adjusting the hinge pin from the pivoted position into the assembly position, in particular in a positive-locking manner,
wherein
the securing element can be adjusted from the release position in the direction of the securing position against a restoring force (FRF), in particular of a spring means, which restores the securing element into the release position.

2. The hinge according to claim 1,
wherein
the securing element can be pivoted about a securing pivot axis (AS), in particular at least substantially parallel to the pin axis (A) of the hinge pin in the pivot position, between the securing position and the release position and/or
in that the securing element is held on the pin receiving element so as to be adjustable between the securing position and the release position.

3. (canceled)

4. The hinge according to claim 1,
wherein
the pin receiver has an assembly opening for inserting the hinge pin into the pin receiver and removing the hinge pin from the pin receiver, and
in that, preferably, the assembly opening is at least partially closed by the securing element in the securing position and
in that, further preferably, the assembly opening is at least substantially released by the securing element in the release position.

5. The hinge according to claim 1,
wherein
the securing element rests on the pin receiving element in the release position in the direction of the restoring force (FRF) returning the securing element to the release position.

6. The hinge according to claim 1,
wherein
the securing element can be adjusted from the securing position in the direction of the release position against a restoring force (FRS), preferably of a spring means, returning the securing element to the securing position and
in that, preferably, the securing element rests on the pin receiving element in the securing position in the direction of the restoring force (FRS) returning the securing element to the securing position.

7. The hinge according to claim 1,
wherein
at least one locking element provided which can be adjusted between a locking position for positively blocking the adjustment of the securing element from the securing position to the release position and an unlocking position for releasing the adjustment of the securing element from the securing position to the release position, and
in that, preferably, in the securing position of the securing element, the locking element in the locking position engages in a positive-locking manner into a locking receptacle of the securing element and, in particular, in the unlocking position is arranged at least substantially outside the locking receptacle.

8. The hinge according to claim 7,
wherein
the locking element can be pivoted between the locking position and the unlocking position about a locking pivot axis (AV), in particular at least substantially parallel or perpendicular to the pin axis (A) of the hinge pin in the pivot position, and/or
in that the locking element is held on the pin receiving element so as to be adjustable between the locking position and the unlocking position.

9. The hinge according to claim 7,
wherein
when adjusting the securing element from the release position to the securing position, the locking element can be automatically adjusted from the unlocking position to the locking position, and/or in that the adjustment of the locking element from the unlocking position to the locking position is blocked in a positive-locking manner by the securing element in the release position and is released in the securing position.

10. The hinge according to claim 8,
wherein
the locking element can be adjusted from the locking position in the direction of the unlocking position, in particular from the locking position to the unlocking position, against a restoring force (FRV), in particular of a spring means, returning the locking element to the locking position and
in that, preferably, the locking element rests on the securing element in the locking position and/or unlocking position in the direction of the restoring force (FRV) returning the locking element to the locking position.

11. The hinge according to claim 1,
wherein
the securing element can be adjusted from the release position to the securing position against a restoring force (FRF), in particular of a spring means, returning the securing element to the release position and
in that, preferably, the securing element rests on the locking element in the release position and/or securing position in the direction of the restoring force (FRF) returning the securing element the release position.

12. The hinge according to claim 7,
wherein
the locking element can be adjusted from the locking position to the unlocking position and/or back without tools, and/or
in that the locking element has a shaped section for placing a correspondingly designed tool and/or key for adjusting the locking element from the locking position to the unlocking position and/or back.

13. hinge according to claim 1,
wherein
the securing element has a pin receiver for at least partially receiving the hinge pin, and/or in that the pin receiver of the pin receiving element and/or the pin receiver of the securing element has a cross-section at least substantially arc-shaped at least in sections, and/or
in that the hinge pin has an at least substantially circular cross-section.

14. A system comprising:
a leaf, in particular in the form of a door and/or a flap,
a base part, in particular in the form of a frame, and
at least one hinge,
wherein the leaf can be detachably and pivotably connected to the base part by means of the hinge and
wherein the leaf can be pivoted relative to the base part in the state connected to the base part about a pin axis (A) of the hinge between a closed position for closing an access, in particular delimited at least partially by the base part, and an open position for at least partially releasing the access,
wherein
the hinge is designed according to claim 13.

15. The system according to claim 14,
wherein
the adjustment of the securing element from the securing position to the release position and/or the adjustment of the locking element from the locking position to the unlocking position is blocked in a positive-locking manner by the leaf in the closed position and is released in the open position, or
in that the leaf has an unlocking recess arranged in the closed position of the leaf in the region of the shaped section of the locking element for placing the tool and/or key on the shaped section through the unlocking recess.
